(19) United States
(12) Patent Application Publication
(10) Pub. No.: US 2024/0096567 A1
(43) Pub. Date: Mar. 21, 2024

(54) BACKLIGHT MODULE AND BACKLIGHT KEYSWITCH THEREOF

(71) Applicant: DARFON ELECTRONICS CORP., Taoyuan City (TW)

(72) Inventors: Chao-Yu Chen, Taoyuan City (TW); Po-Yueh Chou, Taoyuan City (TW)

(73) Assignee: DARFON ELECTRONICS CORP., Taoyuan City (TW)

(21) Appl. No.: 18/369,217

(22) Filed: Sep. 18, 2023

Related U.S. Application Data
(60) Provisional application No. 63/408,062, filed on Sep. 19, 2022.
(60) Provisional application No. 63/408,069, filed on Sep. 19, 2022.

(30) Foreign Application Priority Data
May 26, 2023 (TW) 112119691

(51) Int. Cl. H01H 13/83

(52) U.S. Cl. CPC H01H 13/83; H01H 2219/056; H01H 2219/06; H01H 2219/062; H01H 2219/064

(57) ABSTRACT

A backlight module for illuminating a keycap includes a shielding sheet, a light guide panel, a lighting board disposed under the light guide panel, and a first protrusion structure. The shielding sheet includes a light permeable area. The light guide panel is disposed under the shielding sheet and has a light guide hole for accommodating a light source of the lighting board. The first protrusion structure is formed on the shielding sheet and protrudes toward the light source. The first protrusion structure is at least partially not overlapped with the light source in a vertical direction, for reflecting and scattering at least partial light of the light source to enter the light guide panel for lateral transmission.

### CROSS REFERENCE TO RELATED APPLICATIONS

This application claims the benefit of U.S. Provisional Application No. 63/408,062, filed on Sep. 19, 2022. Further, this application claims the benefit of U.S. Provisional Application No. 63/408,069, filed on Sep. 19, 2022. The contents of these applications are incorporated herein by reference.

### BACKGROUND OF THE INVENTION

### 1. Field of the Invention

The present invention relates to a backlight module and a backlight keyswitch thereof, and more specifically, to a backlight module having a protrusion structure protruding toward a light source and not overlapping with the light source in a vertical direction to make more light enter a light guide panel for lateral transmission and a backlight keyswitch thereof.

### 2. Description of the Prior Art

As technology advances, there are many types of keyboards in use. Users pay much more attention to visual effect of keyboard except basic input function while choosing keyboard. So far a lighting keyboard has been developed. The lighting keyboard attracts users in visual effect and can be used in darkness. When the lighting keyboard of the prior art applies a low luminous light emitting diode (LED) to illuminate each of square keyswitches, the following problems may occur: 1) the main symbol above the LED is over-illuminated and the corner symbol(s) of the keycap is too dark; 2) the surrounding outlet for the keycap peripheral is inconsistent; and 3) the overall illuminating consistency on a single square keyswitch and on plural keyswitches are both not good.

### SUMMARY OF THE INVENTION

According to an embodiment, a backlight module provided by the present invention for illuminating at least one keycap includes a shielding sheet, a light guide panel, a lighting board, and a first protrusion structure. The shielding sheet has a light permeable area. The light guide panel is disposed under the shielding sheet and has a light guide hole. The lighting board is disposed under the light guide panel and has a light source accommodated within the light guide hole. The first protrusion structure is formed on the shielding sheet and protrudes toward the lighting board. The first protrusion structure at least partially not overlaps with the light source in a vertical direction. The first protrusion structure reflects and scatters at least partial light of the light source to enter the light guide panel for lateral transmission.

According to another embodiment, a backlight keyswitch provided by the present invention includes a keycap, a support plate, and the aforesaid backlight module. The support plate is disposed under the keycap. The backlight module is disposed under the support plate.

According to another embodiment, a backlight keyswitch provided by the present invention includes a keycap, a support plate, and a backlight module. The support plate is disposed under the keycap. The backlight module is disposed under the support plate and includes a shielding sheet, a lighting board, and a light guide panel. The shielding sheet has a light permeable area corresponding to the keycap. The lighting board is disposed under the shielding sheet and has a light source. The light guide panel has a light guide hole to accommodate the light source. An inclined surface structure is formed along an edge of the light guide hole and tilted toward the shielding sheet to guide at least partial light of the light source to enter the light guide panel via the inclined surface structure for lateral transmission.

These and other objectives of the present invention will no doubt become obvious to those of ordinary skill in the art after reading the following detailed description of the preferred embodiment that is illustrated in the various FIGS. and drawings.

### BRIEF DESCRIPTION OF THE DRAWINGS

FIG. 1 is a cross-sectional diagram of a backlight keyswitch according to one embodiment of the present invention.

FIG. 2 is an exploded diagram of a support plate, a shielding sheet, a light guide panel, and a lighting board in FIG. 1.

FIG. 3 is a stacking diagram of the backlight keyswitch according to an embodiment of the present invention.

FIG. 4 is a top perspective view of a keycap, the support plate, a first protrusion structure and a light source in FIG. 1.

FIG. 5 is a cross-sectional diagram of a backlight keyswitch according to another embodiment of the present invention.

FIG. 6 shows different protrusion structure configurations according to different embodiments of the present invention.

FIG. 7 is a cross-sectional diagram of a backlight keyswitch according to another embodiment of the present invention.

### DETAILED DESCRIPTION

The present invention will now be described more specifically with reference to the following embodiments. The advantages and spirit of the invention can be further understood in view of the detailed descriptions and the accompanying drawings. The present invention can be implemented or applied to other different embodiments. Certain aspects of the present invention are not limited by the particular details of the examples illustrated herein. Without departing from the spirit and scope of the invention, the present invention will have other modifications and changes. It should be understood that the appended drawings are not necessarily drawn to scale and the configuration of each component (e.g., hole sizes, a size ratio of ink layers) in the drawings is merely illustrative, not presenting an actual condition of the embodiments. Components with identical names and/or numbers, which are both mentioned in each embodiment of the present invention, represents components with identical or similar structures or functions, and the related description is omitted for simplicity.

Each embodiment of the present invention is to increase the lateral transmission ratio of a light source, that is, to reduce the amount of light reaching main symbols on a keycap above the light source and increase the amount of light reaching side or corner symbol on the keycap. Low-power illuminant units such as mini LED or micro LED applied to low-stroke keyswitches have a short vertical light emitting distance (1-2 mm), while a target light emitting area (covering the main symbol/sub-symbol/keycap boundary halo) is large (about 10-12 mm). If the number and power of the illuminant units are not increased, purely optical manners must be used to prevent light from escaping. However, in a small space, how to make 80% of the light emitted upward from the illuminant unit to expand the light transmission angle so that most of the light can enter a light guide panel and transmit laterally is a big problem. Another problem is that if the light needs to pass through multiple reflections and diffusions around the illuminant unit to smoothly transfer the direction/angle of light transmission to the lateral transmission inside the light guide panel (must meet the critical angle of total reflection), the light will be needlessly lost in the initial light emitting stage of the illuminant unit. Thus, reducing initial light loss is another challenge.

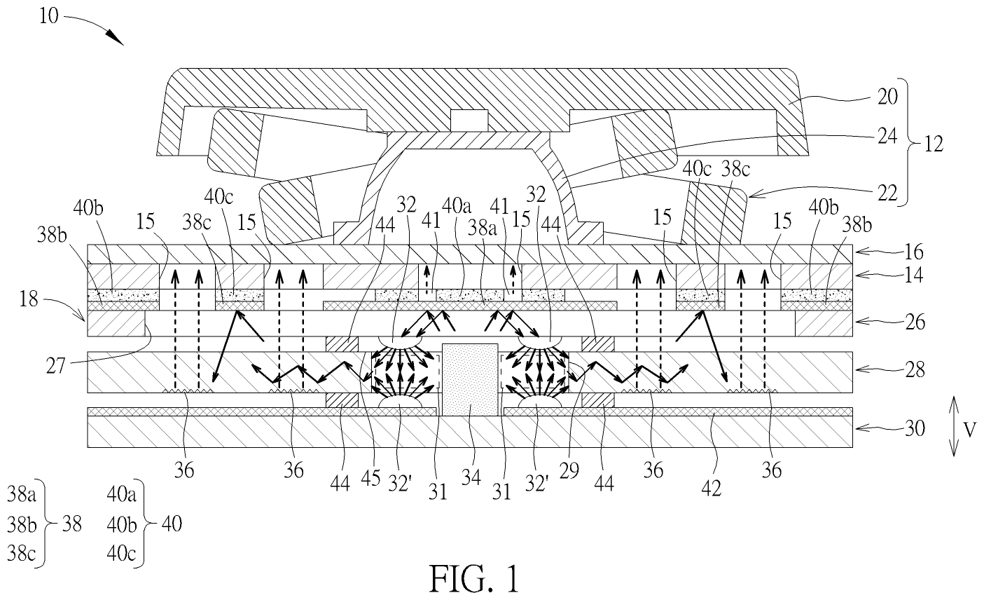

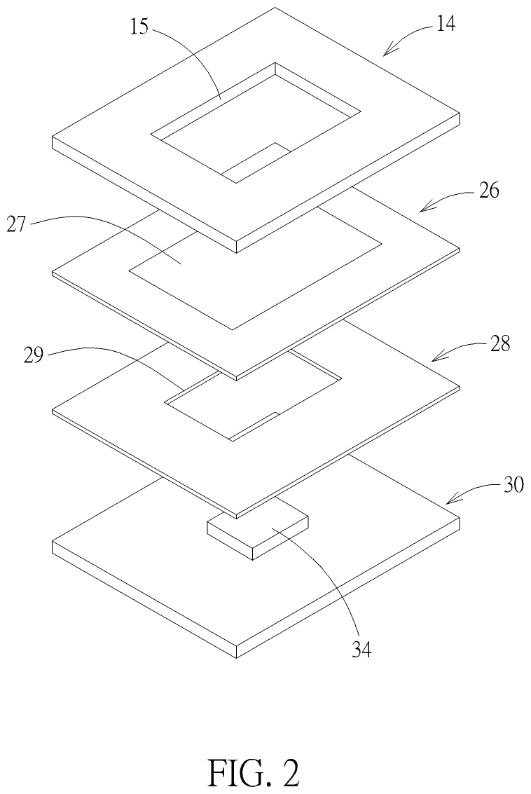

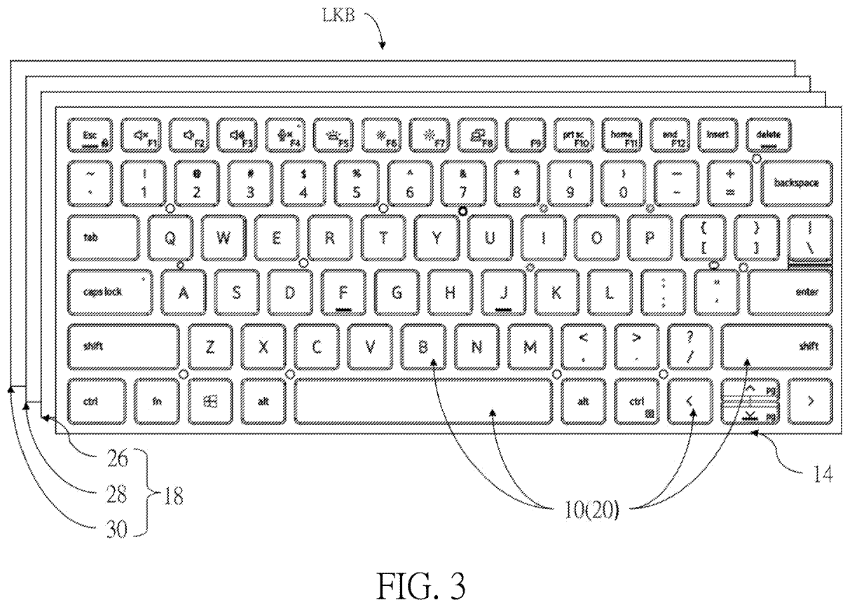

Please refer to FIG. 1, FIG. 2 and FIG. 3. FIG. 1 is a cross-sectional diagram of a backlight keyswitch 10 according to one embodiment of the present invention. FIG. 2 is an exploded diagram of a support plate 14, a shielding sheet 26, a light guide panel 28, and a lighting board 30 in FIG. 1. FIG. 3 is a stacking diagram of the backlight keyboard 10 according to an embodiment of the present invention. The backlight keyswitch 10 could be preferably applied to general electronic devices, such as a backlight keyboard LKB on a notebook or a keyboard device, but not limited thereto. The backlight keyswitch 10 provides a symbol lighting function, so that a user can identify and press to input text, numbers, symbols, or perform other functions. As shown in FIG. 1 and FIG. 2, the backlight keyswitch 10 includes a keyswitch body 12, the support plate 14, and a backlight module 18. As shown in FIG. 1, the keyswitch body 12 could include a keycap 20, a lifting mechanism 22, and a returning member 24. The support plate 14 is disposed under the keyswitch body 12 and the keycap 20 and is connected to the keyswitch body 12 and the keycap 20 so that the keyswitch body 12 and the keycap 20 can move up and down relative to the support plate 14. The support plate 14 has one or more through holes 15 corresponding to the keyswitch body 12. For example, in this embodiment, one through hole 15 is formed at the middle position as shown in FIG. 1 and four through holes 15 are formed at the side positions as shown in FIG. 1, but the present invention is not limited thereto, meaning that the present invention could adopt the embodiment in which there is no hole formed at the middle position of the support plate with light emission only via the through holes at the side positions. When the support plate 14 is opaque (such as made of metal or opaque material), the through holes 15 can allow light from the backlight module 18 to pass therethrough and illuminate the keycap 20. The backlight keyswitch 10 could further include a membrane circuit board 16 (but not limited thereto). The membrane circuit board 16 is disposed in parallel to the keycap 20 and the support plate 14 (e.g., between the keyswitch body 12 and the support plate 14 or under the support plate 14). The membrane circuit board 16 has a keyswitch circuit connected to a plurality of switches, each of which corresponds to one backlight keyswitch 10, and can generate a corresponding keyswitch signal when triggered. The lifting mechanism 22 is connected between the keycap 20 and the support plate 14. The lifting mechanism 22 can rotate and/or move to support the keycap 20 to move up and down. The returning member 24 has elasticity and can provide a returning force to return the keycap 20 to its original position when pressed. The keyswitch body 12 further includes a trigger portion disposed on a lower surface of one of the keycap 20, the returning member 24, or the lifting mechanism 22, and can trigger the switch of the membrane circuit board 16 with the up and down movement of the keycap 20 to generate a keyswitch signal.

In detail, as shown in FIG. 1 and FIG. 3, the backlight module 18 is disposed under the keyswitch body 12, the keycap 20, and the support plate 14, and includes the shielding sheet 26, the light guide panel 28, the lighting board 30, and a first protrusion structure 32, wherein the through hole 15 of the support plate 14 could preferably surround the first protrusion structure 32 in a vertical direction V, but not limited thereto. In a broad sense, the backlight module 18 could also include the support plate 14 and the membrane circuit board 16, because theoretically these multi-layer stacked structures can integrate circuits and components to reduce the total number of layers. To ensure that light escaping from the light guide panel 28 can be recycled to the light guide panel 28 for further transmission, the lighting board 30 and the shielding sheet 26 have a first reflective layer 42 and a second reflective layer 38 respectively facing upper and lower surfaces of the light guide panel 28.

The shielding sheet 26 is disposed between the support plate 14 and the light guide panel 28. For example, the aforesaid second reflective layer 38 could be disposed on a transparent substrate to reduce and/or prevent light from passing through specific positions. In light output positions of the keyswitch body 12 (e.g., symbols and light halos), the shielding sheet 26 does not have the second reflective layer 38 disposed thereon for forming a light permeable area 27. The second reflective layer 38 could be a white ink or paint layer, or could be implemented with a paint containing high-reflection particles or even a metal layer (or metal paint). The second reflective layer 38 usually has a reflectance of at least 15-20%. If necessary, the second reflective layer 38 could also have a considerable transmittance to allow partial light to pass therethrough. The second reflective layer 38 could include an inner reflection area 38a (block-shaped), an outer reflection area 38b (frame-shaped), and a rib reflection area 38c (if necessary). The light permeable area 27 surrounds the inner reflection area 38a and the outer reflection area 38b surrounds the light permeable area 27, so that the light permeable area 27 is surrounded by the inner reflection area 38a and the outer reflection area 38b. The outer reflection area 38b corresponds to inner and outer peripheral areas of the keycap 20 to avoid the user from seeing high-brightness points (e.g., micro-structures introduced later) under the through hole 15 of the support plate 14 via a seam around the keycap 20. The rib reflection area 38c is disposed between the inner reflection area 38a and the outer reflection area 38b, and is spaced apart by a distance. The inner reflection area 38a corresponds to an area covering a light source 34, which is to reflect the strongest light into the light guide panel 28 to avoid the over-brightness problem on main symbols of the keycap 20. This is advantageous to increase the brightness of side or corner symbols and improve the lighting uniformity of the backlight keyswitch 10. If necessary, the shielding sheet 26 could include a mask layer 40. The mask layer 40 is formed above the shielding sheet 26 and covers the light source 34 in the vertical direction V to further block light passing through the second reflective layer 38. The mask layer 40 could be a black ink layer or a metal paint layer, and is formed above the second reflective layer 38 corresponding to the light source 34. The mask layer 40 could be divided into an inner mask area 40a, an outer mask area 40b, and a rib mask area 40c. Furthermore, in practical application, the mask layer 40 could have at least one light compensation hole 41 (two shown in FIG. 1, but not limited thereto). Accordingly, in addition to blocking light passing through the second reflective layer 38, the mask layer 40 could also allow light emitted upward by the light source 34 to pass through the light compensation hole 41, the through hole 15 and the membrane circuit board 16 to be incident to the keycap 20. As such, the present invention can generate the brightness compensation effect for further improving the lighting uniformity of the backlight keyswitch 10.

The light guide panel 28 is located under the shielding sheet 26, and the lighting board 30 is disposed under the light guide panel 28 and has the light source 34. The light guide panel 28 has a light guide hole 29 (preferably a circular hole, but not limited thereto, meaning that the present invention could adopt other light guide hole designs, such as a square hole design) corresponding to the keyswitch body 12/keycap 20/light source 34. The light source 34 is disposed within the light guide hole 29, and one (or more than one) first protrusion structure 32 is at least partially disposed within the light guide hole 29. The first reflective layer 42 and the second reflective layer 38 could at least partially overlap with the first protrusion structure 32 and the light guide hole 29 in the vertical direction V. The light source 34 includes one or more light emitting components, such as monochromatic or multiple different color LEDs. The light source 34 also has a phosphor encapsulated on the LED surface, providing diffusion, dimming, or color mixing effects, but is not limited thereto. The light emission range of the light source 34 could include a top surface and four side surfaces. The first protrusion structure 32 is at least partially located within the light emission range of the light source 34. The closer the first protrusion structure 32 is to the light source 34, the more the first protrusion structure 32 can allow a part of light to directly reach the first protrusion structure 32 for reflection and diffusion upon leaving the light source 34. Another part of the light is reflected by the second reflective layer 38 of the shielding sheet 26 and then refracted and diffused through the first protrusion structure 32. The backlight module 18 further includes a micro-structure layer 36, which could be disposed in parallel to the light guide panel 28 and the lighting board 30. The micro-structure layer 36 corresponds to an area under main/sub symbols on the keycap 20. For example, the micro-structure layer 36 could be formed on the upper or lower surface of the light guide panel 28, an upper surface of the reflective layer of the lighting board 30, or independently between the light guide panel 28 and the lighting board 30. The micro-structure layer 36 is a scattering structure, such as metal paint/white paint micro-dots, concave and convex micro-dots, or linear concave and convex structures made of line segments or continuous lines.

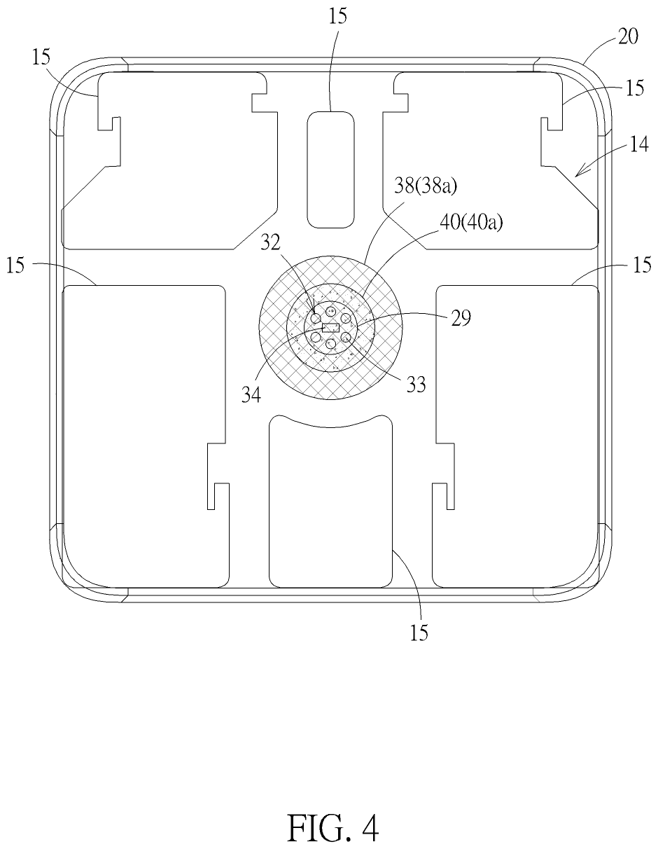

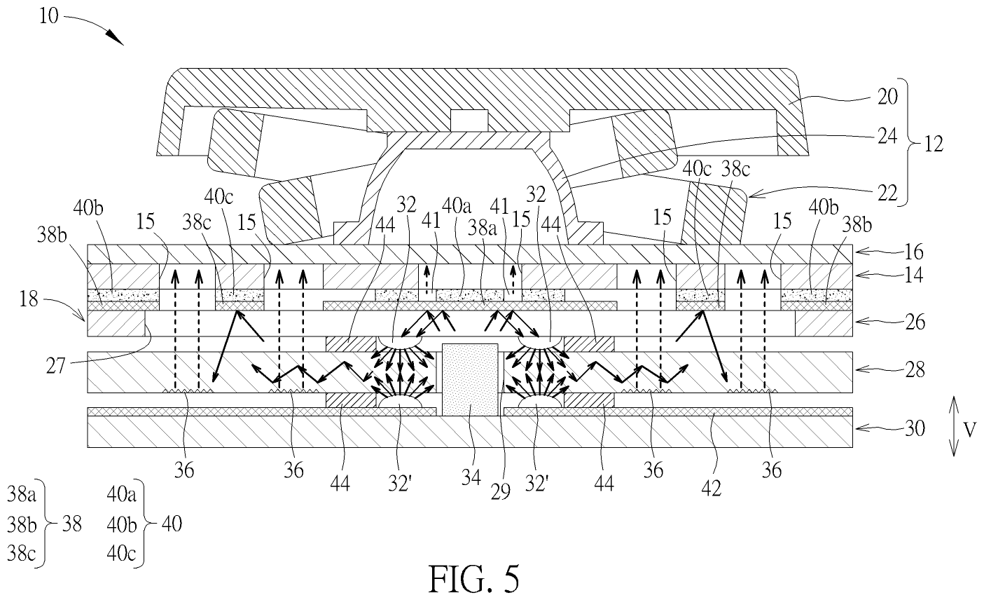

Please refer to FIG. 1 and FIG. 4. FIG. 4 is a top perspective view of the keycap 20, the support plate 14, the first protrusion structure 32, and the light source 34 in FIG. 1. As shown in FIG. 1 and FIG. 4, the first protrusion structure 32 protrudes toward the light source 34, and could be formed on the shielding sheet 26 and at least partially not overlap with the light source 34 in the vertical direction V. The first protrusion structure 32 could be at least partially transparent. Alternatively, via material or structural properties, the surface of the first protrusion structure 32 could also have a good reflectivity. The first protrusion structure 32 could be fixed to the surface of the shielding sheet 26 as an independent component (e.g., by printing or dot-coating with paint, ink, or adhesive to form convex points or particles), or the first protrusion structure 32 could be integrally formed with the shielding sheet 26 (e.g., by mold pressing). A height of the first protrusion structure 32 could be 18% to 95% of a thickness of the light guide panel 28. The major purpose of forming the first protrusion structure 32 is to scatter light to increase the light transmission angle (relative to a norm of a top surface of the light source 34), allowing more lateral light transmission to enter the light guide panel 28 in an initial light emitting stage for achieving lateral transmission of the light in the light guide panel 28 via total reflection. Furthermore, in this embodiment, the light guide hole 29 can preferably be expanded outwardly to form an expanded hole area 31 corresponding to the first protrusion structure 32 in the vertical direction V, to allow at least partial light of the light source 34 to be reflected and diffused by the first protrusion structure 32 within the expanded hole area 31 and then laterally transmitted to the light guide panel 28 (as shown in FIG. 1), thereby improving the lateral transmission proportion of the light source. To be noted, the present invention could omit the aforesaid hole expansion design. For example, as shown in FIG. 5, in the design without expanding the light guide hole 29, the first protrusion structure 32 could be formed outside the light guide hole 29 and overlap with the light guide panel 28 in the vertical direction V to further reduce an optical coupling distance between the first protrusion structure 32 and the light guide panel 28 and increase the amount of light entering the light guide panel 28. Although the drawings of the present invention depict the light guide hole 29 or the expanded hole area 31 in a larger size for the detailed description, in the implementation of a square keycap with a side length of 12-15 mm, a side length of the light guide hole 29 or the expanded hole area 31 could be only 0.5 to 1.2 mm, and each first protrusion structure 32 could have a diameter of no more than 0.1 mm.

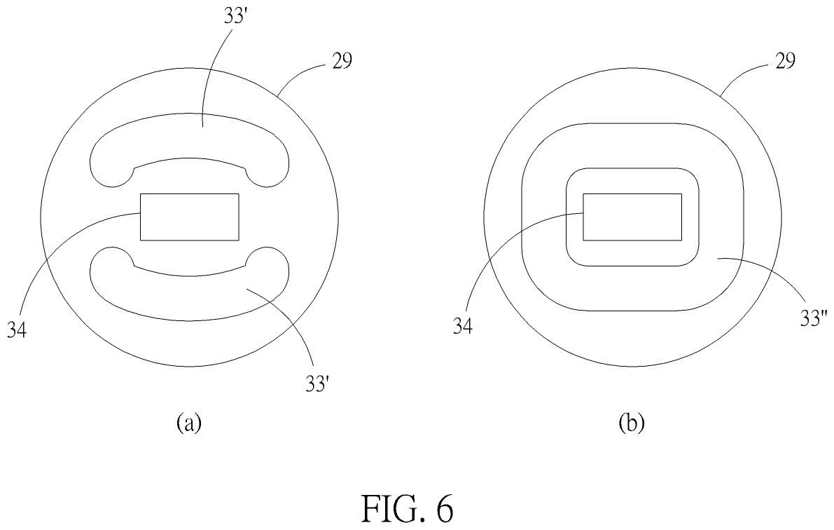

The scattering effect of the first protrusion structure 32 could be generated by the second reflective layer 38 (the inner reflection area 38a) or the first protrusion structure 32 itself. A smooth or rough arc surface of the first protrusion structure 32 or the design that the first protrusion structure 32 is made of reflective material can make the first protrusion structure 32 provide the scattering effect by itself without the second reflective layer 38 (the inner reflection area 38a). The first protrusion structure 32 could have one or more convex points or form a convex/concave dot area to surround the light source 34, such as a horizontal 360-degree and vertical 120-degree elliptical hemisphere. As shown in FIG. 4, the first protrusion structure 32 is preferably composed of a plurality of scattering protrusion points 33 spaced around the light source 34, but the present invention is not limited thereto, meaning that the present invention could adopt other continuous or discontinuous protrusion structure configurations. For example, please refer to FIG. 6, which shows different protrusion structure configurations according to different embodiments of the present invention. As shown in FIG. 6(a), the first protrusion structure 32 is composed of at least two arc-shaped scattering layers 33′ discontinuously surrounding the light source 34. As shown in FIG. 6(b), the first protrusion structure 32 is a continuous annular scattering layer 33″ around the light source 34. No matter whether the first protrusion structure 32 is composed of the plurality of scattering protrusion points 33, composed of the at least two arc-shaped scattering layers 33′, or achieved by the continuous annular scattering layer 33″, “a lowest point of the first protrusion structure 32 does not overlap with the light source 34” implies that the first protrusion structure 32 and the light source 34 are misaligned with each other. This arrangement ensures that an inclined or tilted surface (or other non-horizontal/non-vertical regular or irregular surfaces) of the first protrusion structure 32 faces the light source 34 to refract, reflect, and/or scatter light directly or indirectly coming from the light source 34, the second reflective layer 38 of the shielding sheet 26, or the first reflective layer 42 of the lighting board 30, thereby increasing the proportion of light laterally transmitted into the light guide panel 28.

The aforesaid protrusion structure design could also be applied to the lighting board. For example, as shown in FIG. 1, the backlight module 18 could further include a second protrusion structure 32′ formed on the lighting board 30 and at least partially surrounding the light source 34. Accordingly, the second protrusion structure 32′ can scatter light of the light source 34 to increase or expand the light transmission angle (relative to the normal of the top surface of the light source 34), allowing more lateral light transmission to enter the light guide panel 28 in the initial light emitting stage for achieving lateral transmission of the light in the light guide panel 28 via total reflection. The second protrusion structure 32′ could be fixed to the surface of the lighting board 30 as an independent component (e.g., by printing or dot-coating with paint, ink, or adhesive to form convex points), or the second protrusion structure 32′ could be integrally formed with the lighting board 30 (e.g., by mold pressing). A height of the second protrusion structure 32′ could be 18% to 95% of the thickness of the light guide panel 28. As for the related description for different configurations of the second protrusion structure 32′ (e.g., the scattering protrusion points, the arc-shaped scattering layers, or the annular scattering layer), it could be reasoned by analogy according to FIG. 6 and omitted herein.

Moreover, the present invention could further adopt an adhesive layer design. For example, as shown in FIG. 1, the backlight module 18 could further include at least one adhesive layer 44. FIG. 1 shows one adhesive layer 44 attached between the shielding sheet 26 and the light guide panel 28, and this adhesive layer 44 at least partially surrounds the first protrusion structure 32, the second protrusion structure 32′, the light guide hole 29, and the light source 34. FIG. 1 also shows another adhesive layer 44 attached between the light guide panel 28 and the first reflective layer 42, and this adhesive layer 44 at least partially surrounds the first protrusion structure 32, the second protrusion structure 32′, the light guide hole 29, and the light source 34. The aforesaid adhesive layer 44 is parallel to the shielding sheet 26, parallel to the light guide panel 28, and also parallel to the lighting board 30. Between the adhesive layer 44 and the light guide hole 29 of the light guide panel 28, a non-adhesive area 45 could be preferably disposed to avoid the adhesive layer 44 from entering the light guide hole 29 of the light guide panel 28 and sticking to the light source 34 during the manufacturing process, causing excessive light emission or causing the light source 34 to fall off. The non-adhesive area 45 could be disposed on the upper surface of the light guide panel 28 (or between the light guide panel 28 and the shielding sheet 30), or the non-adhesive area 45 could also be disposed on the lower surface of the light guide panel 28 (or between the light guide panel 28 and the lighting board 32). The adhesive layer 44 has a good light coupling effect. Via the aforesaid adhesive layer design, light of the light source 34 can smoothly reach the medium at the other side of the adhesive layer 44 when the light is directly or indirectly incident to the adhesive layer 44, so that the light can be reflected between the second reflective layer 38 and the first reflective layer 42 and then guided back to the light guide panel 28 after being emitted from the light guide panel 28. As such, the present invention can avoid light loss in an air gap between the light guide panel 28 and the shielding sheet 26 or in another air gap between the light guide panel 28, the lighting board 30 and the first reflective layer 42. In such a manner, the present invention ensures that a sufficient proportion of light can continue to be transmitted laterally to farther positions in the light guide panel 28.

Via the aforesaid configuration, the first protrusion structure 32 and the second protrusion structure 32′ can scatter light to expand the light transmission angle (relative to the norm of the top surface of the light source 34), increase the lateral light transmission, and allow more light to enter the light guide panel 28 for lateral transmission in the initial light emitting stage. Furthermore, via the light coupling effect of the adhesive layer 44 surrounding the first protrusion structure 32 and the second protrusion structure 32′, the initially scattered light can be guided back into the light guide panel 28. Moreover, the light escaping from the upper and lower surfaces of the light guide panel 28 can be reflected back to the light guide panel 28 by the first reflective layer 42 and the second reflective layer 38, thereby ensuring as much as possible that more light can reach the sides and corners of the keycap 20. At this time, the micro-structure layer 36 (as shown in FIG. 1) can scatter the light upward to pass through the light guide panel 28. As such, the light can continue to pass through the light permeable area 27 of the shielding sheet 26, the through hole 15 of the support plate 14, and the membrane circuit board 16, and then be emitted out of the keycap 20, thereby generating the symbol lighting effect and the surrounding halo effect of the keycap 20 and achieving a preferable lighting uniformity.

In summary, the present invention adopts the design in which the protrusion structure is not overlapped with the light source in the vertical direction, to reflect and scatter light of the light source in the initial light emitting stage, thereby expanding the light transmission angle, increasing the lateral light transmission, and increasing the amount of light entering the light guide panel 28. In such a manner, the present invention not only avoids the excessive brightness of middle symbols, but also increases the brightness of side or corner symbols, so as to greatly improve the lighting uniformity and the visual effect of the backlight keyswitch in use.

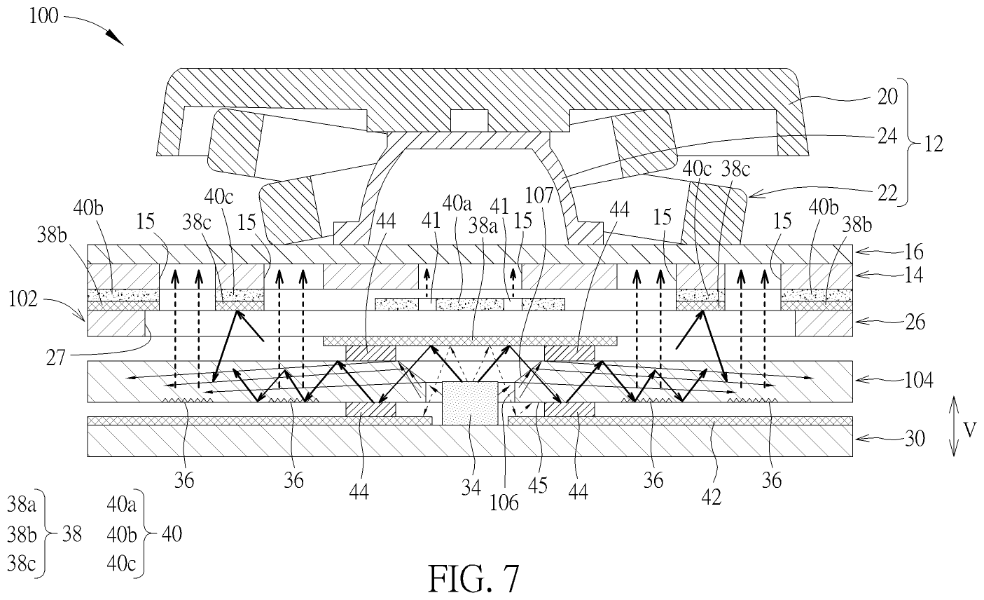

It should be mentioned that the present invention could adopt an inclined surface design of the light guide panel to enhance the lateral transmission ratio of the light source. For example, please refer to FIG. 7, which is a cross-sectional diagram of a backlight keyswitch 100 according to another embodiment of the present invention. Components both mentioned in this embodiment and the aforesaid embodiments represent components with identical or similar structures or functions, and the related description is omitted herein. As shown in FIG. 7, the backlight keyswitch 100 could include the keyswitch body 12, the support plate 14, the membrane circuit board 16, and a backlight module 102. The backlight module 102 includes the shielding sheet 26, the lighting board 30, and a light guide panel 104. In this embodiment, the inner mask area 40a and inner reflection area 38a are respectively formed on the upper and lower surfaces of the shielding sheet 26 (but not limited thereto, meaning that the present invention could adopt the configuration in which the inner mask area 40a and inner reflection area 38a are stacked on the upper surface (as shown in FIG. 1) or the lower surface of the shielding sheet 26). The light guide panel 104 has a light guide hole 106 to accommodate the light source 34, and the light guide hole 106 forms an inclined surface structure 107 (formed continuously or discontinuously along at least partial edge of the light guide hole 106) tilted toward the shielding sheet 26. The inclined surface structure 107 is at least partially higher than the light source 34 in the vertical direction V relative to the lighting board 30. The first reflective layer 42 and the second reflective layer 38 could partially overlap with the light guide hole 106 and the inclined surface structure 107 in the vertical direction V. The through hole 15 of the support plate 14 could preferably surround the inclined surface structure 107 in the vertical direction V (but not limited thereto).

Via the aforementioned design, at least partial light of the light source 34 can enter the light guide panel 104 laterally via the inclined surface structure 107. To be more specific, as shown in FIG. 7, the light of the light source 34 can enter the light guide panel 104 laterally through at least three light paths. As shown by bold solid arrows in FIG. 7, the light can be emitted from the top surface of the light source 34, reflected by the second reflective layer 38, and then incident to the inclined surface structure 107. Furthermore, as shown by dashed arrows in FIG. 7, the light can be emitted from the top surface of the light source 34, sequentially reflected by the second reflective layer 38 and the first reflective layer 42, and then incident to a lower surface of the light guide panel 104. Moreover, as shown by thin solid arrows in FIG. 7, the light can be emitted from the side surface of the light source 34 and directly incident to the inclined surface structure 107 to transmit laterally to a further distance by total reflection. Thus, via the design that the light guide panel has the inclined surface structure at least partially higher than the light source, the present invention not only avoids the excessive brightness of middle symbols, but also increases the brightness of side or corner symbols, so as to greatly improve the lighting uniformity and the visual effect of the backlight keyswitch in use. In practical application, the optical designs mentioned in the aforesaid embodiments (e.g., the protrusion structure design, the hole expansion design, and the adhesive/non-adhesive design) could be selectively applied to this embodiment. The related description (for example, the adhesive layer could be parallel to the light guide panel and at least partially surround the inclined surface structure, or the light guide panel could have the non-adhesive area located between the adhesive layer and the inclined surface structure) could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module for illuminating at least one keycap, the backlight module comprising:
a shielding sheet having a light permeable area;
a light guide panel disposed under the shielding sheet and having a light guide hole;
a lighting board disposed under the light guide panel and having a light source accommodated within the light guide hole; and
a first protrusion structure formed on the shielding sheet and protruding toward the lighting board, the first protrusion structure at least partially not overlapping with the light source in a vertical direction, and the first protrusion structure reflecting and scattering at least partial light of the light source to enter the light guide panel for lateral transmission.

2. The backlight module of claim 1 further comprising:
a first reflective layer formed on the lighting board, the first reflective layer at least partially overlapping with the first protrusion structure and the light guide hole in the vertical direction.

3. The backlight module of claim 1 further comprising:
a second reflective layer formed on the shielding sheet, the second reflective layer at least partially overlapping with the first protrusion structure and the light guide hole in the vertical direction.

4. The backlight module of claim 1 further comprising:
a mask layer formed above the shielding sheet and covering the light source in the vertical direction.

5. The backlight module of claim 1, wherein the first protrusion structure is composed of a plurality of scattering convex points spaced around the light source, is composed of at least two arc-shaped scattering layers discontinuously formed around the light source, or is an annular scattering layer continuously formed around the light source.

6. The backlight module of claim 1 further comprising:
a second protrusion structure formed on the lighting board and at least partially surrounding the light source, the second protrusion structure reflecting and scattering at least partial light of the light source to enter the light guide panel for lateral transmission.

7. The backlight module of claim 1, wherein a lowest point of the first protrusion structure does not overlap with the light source.

8. The backlight module of claim 1, wherein the backlight module further comprises at least one adhesive layer disposed in parallel to the light guide panel and at least partially surrounding the first protrusion structure in the vertical direction.

9. The backlight module of claim 1, wherein the backlight module further comprises at least one adhesive layer disposed in parallel to the light guide panel, and the light guide panel has a non-adhesive area located between the at least one adhesive layer and the first protrusion structure.

10. The backlight module of claim 1, wherein the first protrusion structure is formed outside the light guide hole and overlaps with the light guide panel in the vertical direction.

11. A backlight keyswitch comprising:
a keycap;
a support plate disposed under the keycap; and
a backlight module of claim 1 disposed under the support plate.

12. The backlight keyswitch of claim 11, wherein the support plate has a plurality of through holes surrounding the first protrusion structure in the vertical direction.

13. A backlight keyswitch comprising:
a keycap;
a support plate disposed under the keycap; and
a backlight module disposed under the support plate, the backlight module comprising:
a shielding sheet having a light permeable area corresponding to the keycap;
a lighting board disposed under the shielding sheet and having a light source; and
a light guide panel having a light guide hole to accommodate the light source, an inclined surface structure being formed along an edge of the light guide hole and tilted toward the shielding sheet to guide at least partial light of the light source to enter the light guide panel via the inclined surface structure for lateral transmission.

14. The backlight keyswitch of claim 13, wherein the backlight module further comprises:
a first reflective layer formed on the lighting board, the first reflective layer at least partially overlapping with the light guide hole and the inclined surface structure in the vertical direction.

15. The backlight keyswitch of claim 13, wherein the backlight module further comprises:
a second reflective layer formed on the shielding sheet, the second reflective layer at least partially overlapping with the light guide hole and the inclined surface structure in the vertical direction.

16. The backlight keyswitch of claim 13, wherein the backlight module further comprises:
a mask layer formed above the shielding sheet and covering the light source in the vertical direction.

17. The backlight keyswitch of claim 13, wherein the backlight module further comprises:
a first protrusion structure formed on the shielding sheet and protruding toward the lighting board, the first protrusion structure at least partially not overlapping with the light source in the vertical direction, and the first protrusion structure reflecting and scattering at least partial light of the light source to enter the light guide panel for lateral transmission.

18. The backlight keyswitch of claim 13, wherein the backlight module further comprises at least one adhesive layer disposed in parallel to the light guide panel and at least partially surrounding the inclined surface structure in the vertical direction.

19. The backlight keyswitch of claim 13, wherein the backlight module further comprises at least one adhesive layer disposed in parallel to the light guide panel, and the light guide panel has a non-adhesive area located between the at least one adhesive layer and the inclined surface structure.

20. The backlight keyswitch of claim 13, wherein the support plate has a plurality of through holes surrounding the inclined surface structure in the vertical direction.
